(19) United States
(12) Patent Application Publication
(10) Pub. No.: US 2001/0034654 A1
(43) Pub. Date: Oct. 25, 2001

(54) Interactive internet advertising and e-commerce method and system

(76) Inventors: Todd W. L. Vigil, Scottsdale, AZ (US); Elizabeth S. Vigil, Scottsdale, AZ (US)

Correspondence Address: STONEMAN LAW OFFICES, LTD, 3113 NORTH 3RD STREET, PHOENIX, AZ, 85012, US

(21) Appl. No.: 09/852,497

(22) Filed: May 10, 2001

Related U.S. Application Data
(63) Continuation-in-part of application No. 09/568,292, filed on May 10, 2000.
(60) Provisional application No. 60/133,771, filed on May 12, 1999.
(60) Provisional application No. 60/141,866, filed on Jun. 29, 1999.

(51) Int. Cl. G06F 17/60

(52) U.S. Cl. 705/14

(57) ABSTRACT

The present invention includes a method and system for interactive Internet advertising and e-commerce. The method and system delivers advertisements to viewers wherein a viewer is rewarded for viewing advertisements by being offered the opportunity to win prizes, request information from the advertiser or link directly to the advertiser's e-commerce site. In one embodiment the advertisements are delivered in series as interstitial, full-screen or full browser window, static or dynamic ads. In a further embodiment, the viewers are offered the opportunity to win prizes, request information, or link to the advertiser's web site only after viewing the ad for a period of time without having these opportunities.

### REFERENCE TO RELATED APPLICATIONS

This application is a continuation-in-part of our previous U.S. utility patent application filed May 10, 2000 and having Ser. No. 09/568,292, now abandoned, which application is related to and claims the benefits under 35 U.S.C. Sec. 119(e) of our previous U.S. provisional patent applications, Serial No. 60/133,771 filed on May 12, 1999, and Ser. No. 60/141,866 filed on Jun. 29, 1999.

### BACKGROUND

The present invention relates generally to advertising and, more particularly, to a method and system for interactive advertising, especially in Internet advertising, where the viewer is offered the opportunity to win a prize and optionally obtain information, including literature, product samples or incentives from an advertiser in exchange for viewing an advertisement.

Advertisements have been used for decades to promote and sell products and services through a wide variety of media including: television, radio, billboards, magazines and, more recently, the Internet. Typically, advertisements have been presented through these media channels by being interlaced with entertainment or informational programming that attracted the viewer, listener or reader. In exchange for receiving free or subsidized content or programming, the viewer is exposed to advertisements which support the cost of producing and providing the content or programming. This method of advertising has been applied to every type of media from commercials in radio and television to advertisement pages in newspapers and magazines to banner ads on web pages, etc.

Despite the widespread usage of these methods, it is well known that a viewer, listener and/or reader can all too easily receive the entertainment or informational content of the media while ignoring the advertisement. For example, it is typical for television viewers or radio listeners to change channels or engage in another activity during advertisements. Likewise it is all too easy for a reader or viewer of a newspaper, periodical or web site to ignore the advertising frames or pages. To reduce these problems, advertisers attempt to develop advertisements which will capture and hold a viewer's attention by making an advertisement that is in itself entertaining or interesting to the viewer. Unfortunately, if the viewer changes channels, goes to another web page or turns the page before the advertisement catches the viewer's attention, the advertiser has paid for an ad that has had no impact as to that viewer.

### OBJECTS OF THE INVENTION

It is an object and feature of the present invention to provide a solution to these above-mentioned problems of the prior art by presenting a new and effective system for presenting advertisements to consumers. It is a further object and feature of this invention to provide a system for the interactive display of advertisements to viewers wherein in exchange for viewing advertisements a viewer is rewarded with the opportunity to win prizes and obtain information, including literature, product samples or incentives from the advertiser. Another object and feature hereof to provide a system wherein an advertisement is transmitted to a viewer for viewing, an offer to enter to win a prize is transmitted to the viewer, an entry is received back from the viewer, and at least one entry is selected to win the prize from among all the viewers who received the advertisement and submitted entries.

Moreover, it is an additional object and feature of one aspect hereof to provide that a plurality of interstitial, full-screen or full browser window, static or dynamic advertisements be transmitted to the viewer in series, wherein no other content is present, and the advertisements are the featured presentation. And it is an object and feature of another aspect hereof to provide that the viewer is only offered the opportunity to enter to win the prize after the viewer has viewed an advertisement for a period of time during which the opportunity to submit an entry to win a prize was not available. A further object and feature hereof is to provide offering the viewer the opportunity to request product or service information, including literature, product samples or incentives from the advertiser, and/or to store a link to the advertiser's e-commerce site. It is a further object, feature, and advantage of this invention is to provide a system wherein the incentive for viewing the advertisement is virtually inseparable from the advertisement in that the incentive for viewing the advertisement in the present invention—the opportunity to win a prize—is presented in conjunction with, in connection with, the advertisement, thus providing that a viewer who submits an entry is likely to have viewed the entire advertisement and at a minimum will probably have viewed at least a portion of the advertisement that was connected with the opportunity to submit the entry.

Further objects, features and advantages of the present invention as well as the structure and operation of various embodiments of the present invention are described in detail below with reference to the accompanying drawings.

### SUMMARY OF THE INVENTION

According to a preferred embodiment thereof, this invention provides a system of advertising to a viewer wherein by viewing an advertisement of an advertiser a viewer may qualify to win a prize, comprising: transmitting an advertisement to a viewer; transmitting to the viewer an offer to submit an entry to win a prize in response to the advertisement wherein the viewer is offered the opportunity to submit the entry only after the advertisement has been displayed to the viewer for a period of time; receiving an entry for the prize from the viewer; and selecting an entry as a winning entry to receive a prize. It also provides, in accordance with a preferred embodiment thereof, a system of advertising to at least one viewer wherein by permitting display to the viewer of at least one advertisement, the viewer may qualify to win at least one prize, comprising: displaying to the viewer, in connection with the display of the advertisement, an immediate opportunity to submit at least one entry to win the prize; wherein the viewer is offered the immediate opportunity only after the advertisement has been displayed to the viewer for a period of time.

Moreover, according to a preferred embodiment, this invention provides a computer system of advertising to at least one viewer wherein by permitting display to such at least one viewer of at least one advertisement of at least one advertiser, such viewer may qualify to win at least one prize, comprising: displaying such advertisement to such viewer for a first period of time; and displaying to such viewer, in connection with such displaying of such advertisement, an immediate opportunity to submit at least one entry to win such at least one prize; wherein such viewer is offered such immediate opportunity only after such advertisement has been displayed to such viewer for a second period of time; wherein such immediate opportunity is offered to such viewer only for a third period of time; wherein the second period of time is no more than about the first period of time; and wherein the third period of time is no less than about five seconds. And it provides such a system wherein the first period of time is no less than about five seconds; and, further, wherein the second period of time is no less than about five seconds; and, further, wherein the second period of time is no more than about thirty seconds; and, further, wherein the third period of time is no more than about thirty seconds. It also provides such a system wherein: the second period of time is no less than about five seconds; and the second period of time is no more than about twenty seconds. And it provides such a system further comprising: receiving such at least one entry from such viewer; and selecting such at least one entry as at least one winning entry to receive such at least one prize. Further, it provides such a system further comprising displaying to such viewer an entry system structured and arranged to implement such submission of such at least one entry by viewer “clicking” of at least one designated area of a viewer display device; and, further, wherein such viewer “clicking” is accomplished by only one “click”; and, further wherein such designated area comprises at least one button. Also, it provides such a system wherein such entry system is further structured and arranged to include an optional viewer-opportunity to request information from such advertiser; and, further, wherein such entry system is further structured and arranged to include an optional viewer-opportunity to request linking such viewer to a website of such advertiser. And it provides such a system wherein such button comprises, at least in part, essentially the words “Enter Me”. Also it provides such a system further comprising displaying to such viewer an indication of when such offer will be made of such immediate opportunity to submit such at least one entry to win such at least one prize; and further, wherein such displaying of such advertisement to such viewer comprises such indication; and, further, wherein such indication comprises a countdown of essentially how much time remains of such second period of time. It further provides such a system further comprising: selecting such advertisement to transmit to such viewer from a category of such advertisements requested by such viewer; and selecting such advertisement to transmit to such viewer from a list of advertisers selected by such viewer; wherein such advertisement comprises a dynamic interstitial advertisement.

In addition, in accordance with a preferred embodiment hereof, this invention provides a system of advertising, comprising: preparing an advertisement for display to a viewer in exchange for offering the viewer an opportunity to submit an entry to win a prize in conjunction with viewing the advertisement wherein the opportunity to submit the entry is only available after the advertisement has been displayed to the viewer for a period of time; transmitting the advertisement to an ad server for transmission to viewers; receiving viewer contact information for each viewer selected to win a prize; and transmitting each selected viewer a prize. And, according to another preferred embodiment, it provides a computer system of advertising to at least one viewer wherein, by viewing at least one advertisement of an advertiser, such viewer may qualify to win at least one prize, comprising: storing a plurality of such advertisements on at least one server; registering a plurality of such viewers by obtaining viewer information data for each such viewer including at least such viewers' contact information; and implementing display of at least two of such plurality of such advertisements to at least one selected viewer for display in series on a viewer interface device, such implementing being structured and arranged to provide displaying of each individual advertisement to such selected viewer for a first period of time, displaying to such selected viewer, in connection with the display of such individual advertisement, of an immediate opportunity to submit at least one entry to win such at least one prize, wherein such selected viewer is offered such immediate opportunity only after such individual advertisement has been displayed to such selected viewer for a second period of time, wherein such immediate opportunity is offered to such selected viewer only for a third period of time, wherein the second period of time is no more than about the first period of time, and wherein the third period of time is no less than about five seconds; and determining for each such individual advertisement whether each such selected viewer chose to submit an entry for the associated prize; identifying any such selected viewers, who chose to submit an entry, as entrants; selecting at least one such entrant as a winner to receive such at least one prize; and notifying such at least one winner of a winning of such at least one prize.

Yet additionally, in accordance with a preferred embodiment hereof, this invention provides a computer system of advertising to at least one viewer wherein by permitting display to such at least one viewer of at least one advertisement of at least one advertiser, such viewer may qualify to win at least one prize, comprising: means for displaying such advertisement to such viewer for a first period of time; and means for displaying to such viewer, in connection with such displaying of such advertisement, an immediate opportunity to submit at least one entry to win such at least one prize, so that such viewer is offered such immediate opportunity only after such advertisement has been displayed to such viewer for a second period of time, and such immediate opportunity is offered to such viewer only for a third period of time; wherein the second period of time is set at no more than about the first period of time; and wherein the third period of time is set at no less than about five seconds.

Yet further, according to preferred embodiment, the present invention provides a system of advertising to at least one viewer wherein by permitting display to the viewer of at least one advertisement of an advertiser, the viewer may qualify to win at least one prize, comprising: means for displaying to the at least one viewer, in connection with the display of the at least one advertisement, an immediate opportunity to submit at least one entry to win the at least one prize; and means for offering to the at least one viewer such immediate opportunity only after the at least one advertisement has been displayed to the at least one viewer for a period of time having a first portion of time during which the at least one viewer is not offered such immediate opportunity to submit the at least one entry to win the at least one prize followed by a second portion of time during which the at least one viewer is offered such immediate opportunity to submit the at least one entry to win the at least one prize.

It also provides, according to a preferred embodiment thereof, a computer system for advertising to a viewer wherein, by viewing an advertisement of an advertiser, a viewer may qualify to win a prize, comprising an ad server configured to: transmit an advertisement to a viewer; transmit an offer to submit an entry to win a prize to the viewer in conjunction with viewing the advertisement wherein the viewer is offered the opportunity to submit the entry only after the advertisement has been displayed to the viewer for a period of time; receive an entry for the prize from the viewer; and select an entry as a winning entry to receive a prize. And it provides such a system wherein the ad server is further configured to transmit a plurality of advertisements to the viewer to be displayed in series; and, also wherein the ad server is further configured to select an advertisement for transmission to the viewer based on demographic information of the viewer; and further, wherein the ad server is further configured to select an advertisement to transmit to the viewer from a category of advertisements requested by the viewer; and further, wherein the ad server is further configured to select an advertisement to transmit to the viewer from a list of advertisers selected by the viewer; and, further, wherein the ad server is further configured to receive viewer information data, wherein the viewer information data includes at least viewer contact information; and, further, wherein the ad server is further configured to store the viewer information data for each viewer submitting an entry; and, also wherein the ad server is further configured to select the winning entry from among the stored viewer information data for each viewer submitting an entry; and, also, wherein the ad server is further configured to transmit the viewer information data, for the viewer submitting the winning entry, to the advertiser, whereby the advertiser may send the prize to the winner; and, also, wherein the ad server is further configured to notify the viewer submitting the winning entry that they have won the prize. It also provides such a system wherein the ad server is further configured to offer the viewer an opportunity to request information from the advertiser; and, also, wherein the ad server is further configured to offer the viewer an opportunity to be linked to a website of the advertiser.

Even moreover, according to a preferred embodiment thereof, this invention provides a system for advertising to a viewer wherein by viewing an advertisement of an advertiser a viewer may qualify to win a prize, comprising an ad server configured to: receive a plurality of advertisements; store the advertisements on a server; register a plurality of viewers by obtaining viewer information data for each viewer including at least the viewers' contact information; transmit the plurality of advertisements to each viewer for display on a monitor in series, wherein each advertisement is an interstitial advertisement having an associated prize offering, the advertisement being displayed for a time period having a first portion of time during which the viewer is not offered an opportunity to submit an entry to win the prize followed by a second portion of time during which the viewer is offered the opportunity to submit an entry to win the prize; determine for each advertisement whether each viewer chose to submit an entry for the associated prize; identify the viewers, who chose to submit an entry, as entrants; select an entrant as a winner to receive the prize; and notify the winner that they have won the prize.

And it provides, in accordance with a preferred embodiment, a system for computer executable software code stored on a computer readable medium, the code for advertising to a viewer wherein, by viewing an advertisement of an advertiser, a viewer may qualify to win a prize, comprising: code to transmit to the viewer, in connection with a transmitted advertisement, an offer to submit at least one entry to win a prize in response to the advertisement wherein the viewer only has the opportunity to submit the entry only after the advertisement has been displayed to the viewer for a period of time; code to receive an entry for the prize from the viewer; and code to select an entry as a winning entry to receive a prize. It also provides such a system further comprising code to transmit a plurality of advertisements to the viewer to be displayed in series.

This invention also provides, in accordance with all of the embodiments of this invention, that the prize is preselected by the advertiser; and further, that selection of the advertisement is based on demographic information about the viewer.

### BRIEF DESCRIPTION OF THE DRAWINGS

FIG. 1 illustrates the system architecture of one preferred embodiment of the advertising system according to the present invention.

FIG. 1a illustrates the system architecture of another preferred embodiment of the advertising system according to the present invention.

FIG. 2 illustrates an example ad database according to a preferred embodiment of the present invention.

FIG. 3 illustrates an example of a registered user database according to a preferred embodiment of the present invention according to a preferred embodiment of the present invention.

FIG. 4 is a flow chart illustrating a method of receiving and handling ads, receiving entries and drawing winners according to a preferred embodiment of the present invention.

FIGS. 5a-5b are flow charts illustrating a method of displaying an ad to a viewer and collecting viewer responses according to a preferred embodiment of the present invention.

FIG. 6a illustrates an example screen presented to a viewer according to a preferred embodiment of the present invention.

FIG. 6b illustrates an example screen presented to a viewer, preferably immediately after the example screen of FIG. 6a, according to a preferred embodiment of the present invention, including a note pointing to the area of the screen (including the example bike) where the advertising presentation is preferably made.

FIG. 6c illustrates an example screen presented to a viewer, preferably immediately after the example screen of FIG. 6b, according to a preferred embodiment of the present invention.

FIG. 6d illustrates an example of an alternate preferred screen presented to a viewer which may combine and replace aspects of the example screens of FIGS. 6a, 6b, and 6c.

FIG. 7 illustrates an example screen used to set up a system operator's preferred advertisement specifics, particularly illustrating the same with respect to the advertisement illustrations of FIG. 6.

FIG. 7a illustrates a further example screen used to further set up a system operator's preferred advertisement specifics (as with a button control set up), particularly illustrating the same with respect to the advertisement illustrations of FIGS. 6.

### DETAILED DESCRIPTION OF THE PREFERRED EMBODIMENTS

The present invention is described in terms of the above examples and embodiments. This is for convenience only and is not intended to limit the application of the present invention. In fact, after reading the following description, it will be understood how to implement the present invention in alternative embodiments.

1. Introduction

In various embodiments of the system of the presented invention, which may embody an appropriate method, apparatus, system configuration and/or computer software (defined as a computer readable medium, for example CD ROM, DVD ROM, floppy disk), are provided which implement the system of advertising described herein.

According to one preferred embodiment of this invention, the system presents interactive advertisements (hereinafter “ads”) to viewers wherein the ads are provided as a series of interstitials by the website. Interstitials are full-screen or full browser window, static or dynamic, ads. The system (1) presents interstitial ads that are in themselves entertaining and appealing to the viewers, and (2) offers the viewer the opportunity to interact with/after the ad by submitting an entry to win an offered prize and optionally requesting information, including literature, product samples or incentives from the advertiser, or storing a link or link directly to the advertiser's e-commerce site. The opportunity to win prizes and otherwise interact with the ads in conjunction with the use of ads which are themselves highly entertaining, will draw viewers to watch the ads. To further enhance the viewer's experience and appeal to the viewer's interests, it is also contemplated that, aside from showing ads randomly to viewers, the ad presentation may be viewer dependent, wherein each viewer is shown targeted ads in response to that viewer's demographic information, interests, or request to view ads from a particular product or service category or from particular advertisers.

According to an alternate preferred embodiment of this invention, an ad server is provided and used to provide such entertaining ads, preferably singly, to websites, preferably Internet, wishing such ads along with offering the viewer the opportunity to interact with/after the ad by submitting an entry to win an offered prize and optionally requesting information, including literature, product samples or incentives from the advertiser, or storing a link or link directly to the advertiser's e-commerce site. The operator of the ad server preferably receives such entries and preferably conducts such drawings as to determine at least one prize winner in each contest. Although for this embodiment, interstitial ads are preferred, other formats may, in appropriate circumstances, be used.

Generally, large ads are preferred over small ads. Studies have shown that traditional banners now induce only about half a percent of viewers to click. Larger ads have “click rates” closer to two percent. Personalization preferred over non-Personalization; for example if the ad includes the viewer's name—a possibility on sites that encourage registration—the response rate is about three percent. Rich Media (dynamic) formats are preferred over non-Rich Media (static) formats. For example, if animated elements fly out of the ad and around the page, the click rate is about seven percent. And for ads that pop up in separate windows with sound and motion, the response can top 10 percent. Other ad formats usable under appropriate circumstances include, but are not limited to, Banners, Vertical Units (Skyscrapers), Large Rectangular Units, Square Units, Streaming Audio and Video, Minisites, Pop-Ups and Digitized TV Commercials (as well as Interstitials). In addition, embodiments of the present invention, under appropriate circumstances, can be integrated into the aforementioned ad formats used in permission-based e-mail and wireless marketing campaigns.

“Digitized TV Commercials” are simply advertisers' 30-second TV commercials that have been digitized and used as an Internet format. Interstitials, Minisites and Pop-ups burst open on screens, allowing companies to show games and product information. These ad formats allow advertisers to market without sending people away from the site they're visiting. Interstitials are full-screen ads that occasionally pop up between pages on cutting-edge sites. Interstitials are what TV advertisers have been waiting for on the Web. They get in your face, take up the full browser screen, and don't go away until you click on them or they're done with their animation. The term has been applied to “splash screen” ads, which are simply static ad pages that the user has to click to go to the next page, but it is preferred to think of true interstitials as animated ones lasting preferably 5-15 seconds. The “interstitial” aspect of the ads is that they appear between Web pages. Theoretically, while the user views page A, the interstitial file should download in the background, ready to run instantly when the user clicks to go to page B. The use of Streaming Audio and Video is much like the TV ads that marketing advertisers know and trust; but widespread use will depend on high-speed Net connections, which aren't expected to be adopted by a critical mass of 30 million households for several more years. Vertical Units (Skyscrapers), Large Rectangular Units and Square Units are larger than Banner ad formats currently being introduced by Web publishers and are designed to enable marketers to utilize greater interactivity as well as expand the creativity in their online messaging. Banners are easy to do broadly across the Web. They make up almost 50% of online ad revenue, but their effectiveness may be waning. It is still unknown whether or how much Banners boost a brand.

Certain embodiments of the present invention will now be described with reference to the figures.

2. System Architectures

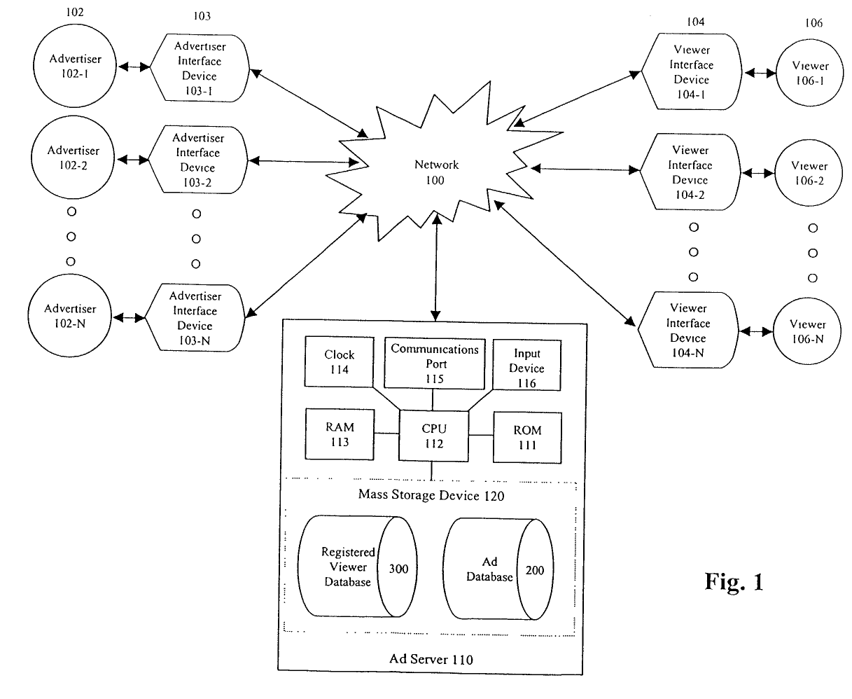

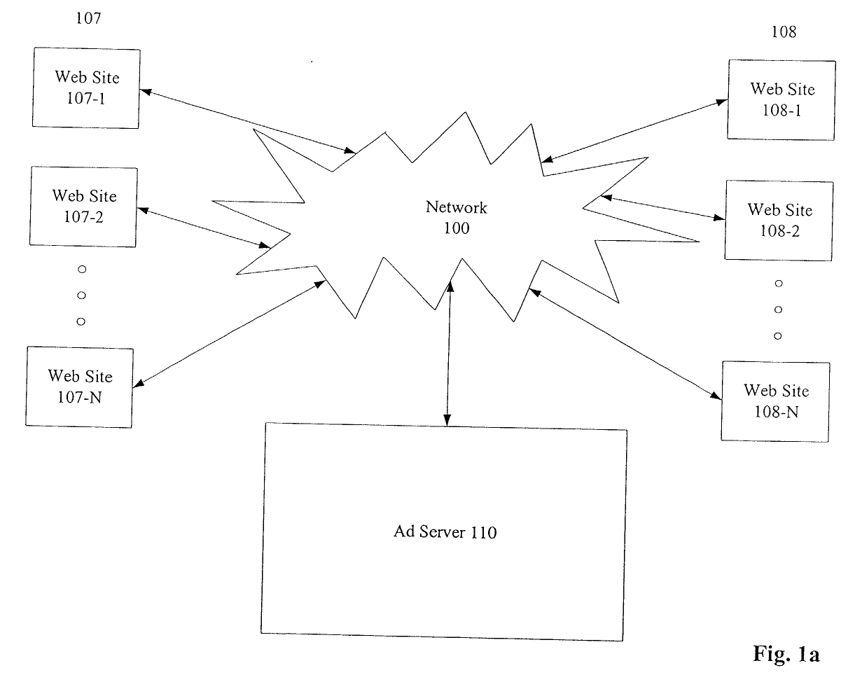

The system architecture of one embodiment of the present invention is illustrated with reference to FIG. 1. As shown in FIG. 1, the system includes an ad server 110, configured to communicate with one or more advertisers 102 through advertiser interface devices 103 and one or more viewers 106 through viewer interface devices 104 (collectively the “nodes”). Each node is connected directly or indirectly to the ad server 110 via a connection to a network 100, such as a local area network (LAN), a wide area network (WAN), the Internet or the like, via a public switched phone network, dedicated data line, cellular network, Personal Communication System (PCS), microwave, satellite networks, cable or the like.

The system architecture of an alternate embodiment of the present invention is illustrated with reference to FIG. 1a. As shown in FIG. 1a, the system includes an ad server 110, having component parts generally as illustrated with respect to FIG. 1, configured to communicate with one or more websites 107 (generally examples of advertiser websites) and 108 (generally examples of general websites visited by “customers” or “viewers”), collectively the “nodes”. Each node is connected directly or indirectly to the ad server 110 via a connection to a network 100, such as a local area network (LAN), a wide area network (WAN), the Internet or the like, via a public switched phone network, dedicated data line, cellular network, Personal Communication System (PCS), microwave, satellite networks, cable or the like.

Ad Server

According to one embodiment, the ad server 110 is implemented as a single general purpose computer as described below. In another embodiment, the functionality of the ad server is distributed over a plurality of computers. In that embodiment, ad server 110 is configured in a distributed architecture, wherein the database and processors are housed in separate units or locations and are connected via a network connection such as those discussed above. Those skilled in the art will appreciate that an almost unlimited number of controllers may be supported. This arrangement yields a more dynamic and flexible system, less prone to catastrophic hardware failures affecting the entire system.

In the embodiments shown in FIGS. 1 and 1a, the ad server 110 is implemented as a single general purpose computer including a central processing unit (CPU) 112, random access memory (RAM) 113, read-only memory (ROM) 111, an input device 116, a communications port 115, a clock 114, and a mass storage device 120 for storing the ad database and the registered viewer database 300. The CPU 112 comprises a conventional microprocessor such as an Intel Pentium processor electrically coupled to each of the ad server's other elements.

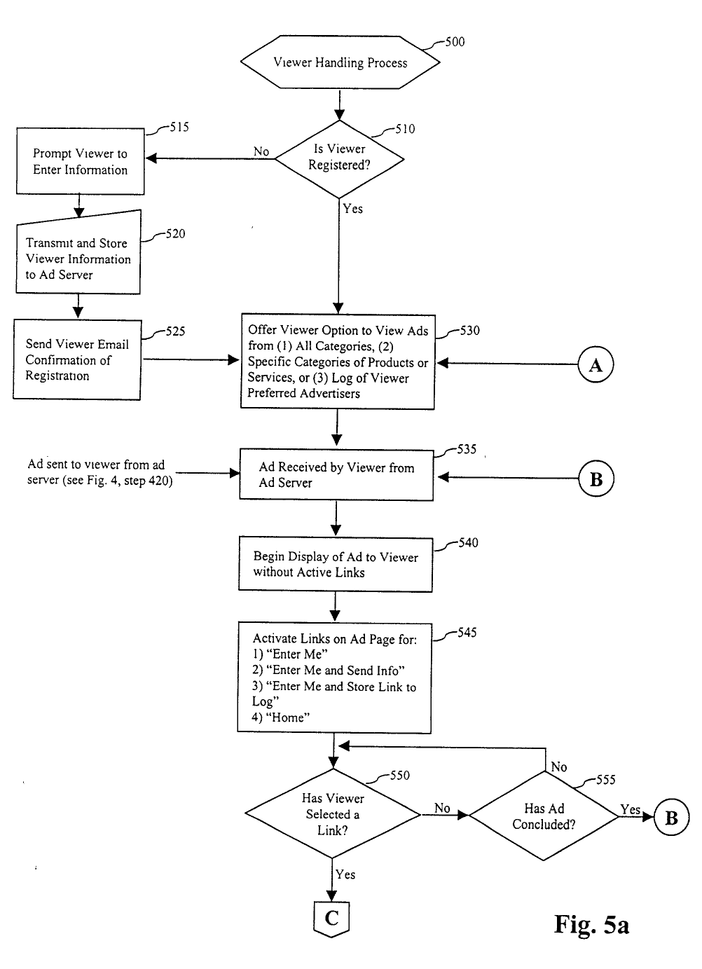

The CPU 112 executes program code stored in one or more of ROM 111, RAM 113 and mass storage device 120 to carry out the functions and acts described in connection with the ad server 110. The CPU 112 comprises at least one high-speed digital data processor adequate to execute program modules for executing ad handling, viewer handling, prize drawing, and reporting processes. These modules are described in connection with FIGS. 4-7. The CPU 112 interacts with ROM 111, RAM 113 and mass storage device 120 to execute stored program code according to conventional data processing techniques.

Advertiser and Viewer Interfaces

According to one embodiment of the invention, each advertiser interface device 103 and each viewer interface device 104 shown in FIG. 1 is a browser based system implemented as a single interactive visual display device, audio device or other like interactive device such as a general purpose computer, a personal digital assistant (PDA), phone, or interactive television system. There are many commercial software programs that can enable the communications required by the interface devices 103 and 104 with the ad server 110, the primary function being transmission and reception of data through the network 100 and presentation of data to the viewer 106. Examples of such software programs include the Netscape Navigator browser by Netscape Corporation and the Internet Explorer browser by Microsoft Corporation.

Each advertiser interface device 103 and viewer interface device 104 is capable of communicating directly or indirectly with the ad server 110. Communication between the advertiser interface devices 103 and viewer interface devices 104, and the ad server 110 is electronic by means of a network 100 and includes a conventional high-speed connection employing known communication protocols, such as TCP/IP, and is capable of decrypting and encrypting data received and transmitted between the nodes.

Communication between ad server 110 and website servers 107 and 108 is usual for networks such as the Internet and conducted as those skilled in the art will, under appropriate circumstances, deem efficient.

3. Overview of the System Process

The ad server 110 may manage any or all of (1) the receipt of ads from advertisers 102, (2) creation and maintenance of an ad database 200, (3) registration of viewers 106, (4) creation and maintenance of a registered viewer database 300, (5) selection and transmission of each ad to a plurality of viewers 106, (6) receiving and recording viewer responses to each ad, (7) management and execution of prize drawings associated with each ad, and (8) reporting prize winners and viewer information to each advertiser 102. Where each website 107, 108 is registering its own viewers, such information is made available to ad server 110 in any usual manners.

The ad server 110 receives ads from advertisers and compiles the ads in an ad database 200. The ad server 110, when appropriate, may also register viewers and compile viewer information in the registered viewer database 300. When a registered viewer 106 logs onto the ad server's web site and requests ads, the ad server 110 (or, for websites 107, 108, the website server there) selects and transmits an ad to the viewer 106. The viewer 106 in turn views the ad and may submit an entry to win a prize, a request for information, including literature, product samples or incentives, or a request to store a link to the advertiser's e-commerce site. The ad server 110 receives and stores the viewer's request in the ad database 200 or registered viewer database 300. For each ad the ad server 110 monitors the number of entries submitted and conducts a drawing at scheduled intervals. The ad server 110 then reports the drawing results to the advertiser 102. The ad server 110 also reports the information request to the advertiser 102 and may provide additional viewer information from the registered viewer database 300 at the advertiser's request.

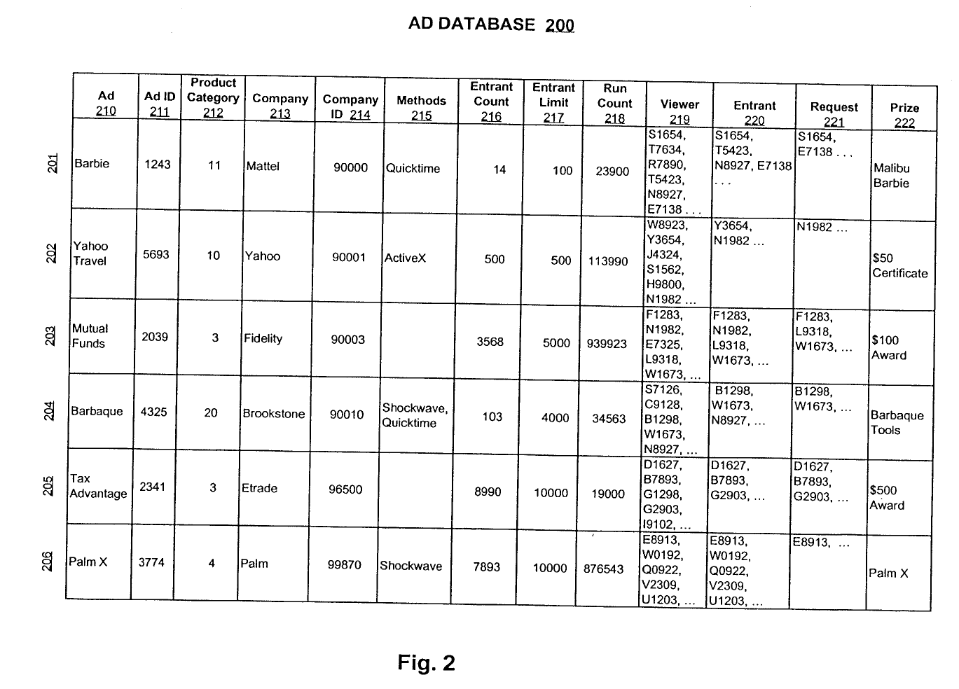

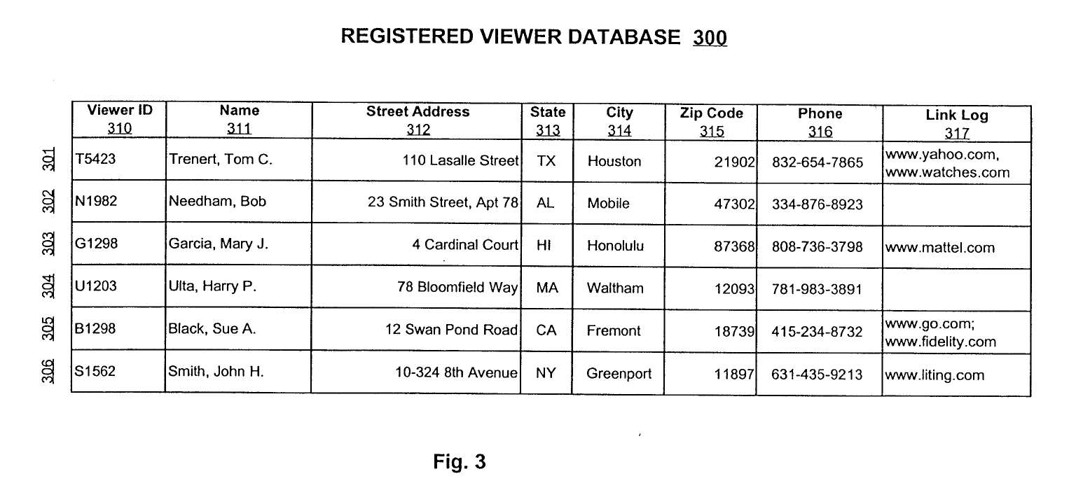

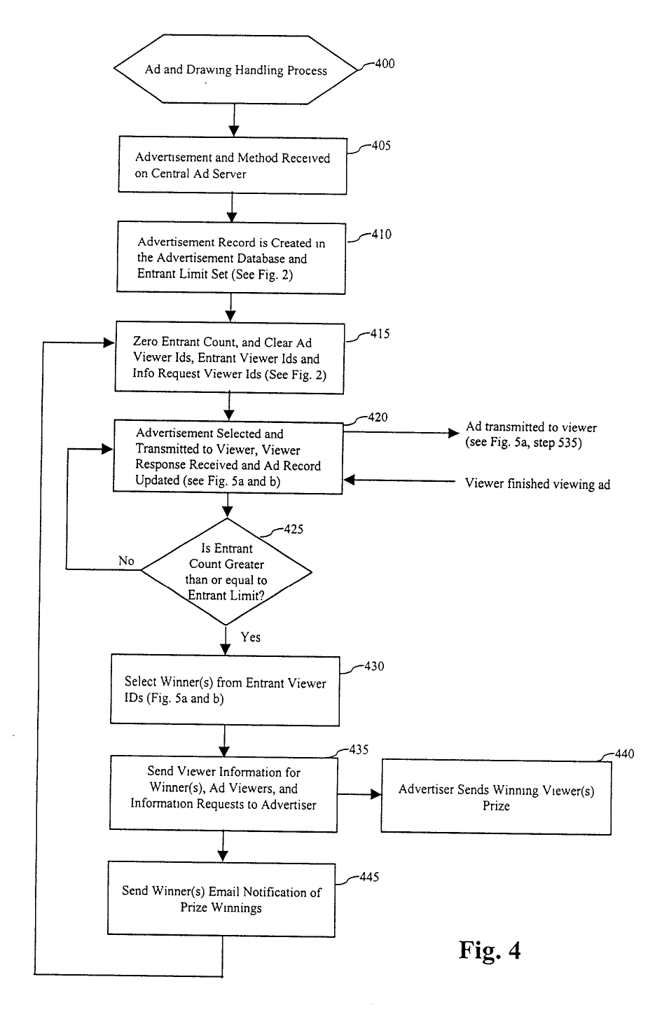

The center of one preferred embodiment of the process revolves around the storage and management of ad, entry and viewer information in the ad database 200 and registered viewer database 300. These databases will now be discussed in detail with reference to exemplary database structures shown in FIGS. 2 and 3.

4. Database Formats

Samples of the contents of ad database 200 and registered viewer database 300 are shown in FIGS. 2 and 3, respectively. The organization of these databases, including specific data and fields illustrated in these figures represents only one embodiment of the records stored in the databases. Moreover, it should be understood that the databases themselves are only representative, that the information contained therein could equally be consolidated into fewer databases or divided up among more databases, and that the databases and their contents could be distributed among one or more storage devices, including storage devices connected to the ad server 110, the advertiser interface device 103 and viewer interface device 104. For example, some of the registered viewer data may be stored in a “cookie” on the viewer's interface device 104, or some of the ad data may be stored on the advertiser's interface device 103, or may be stored, in appropriate circumstances at the websites 108.

Referring to the sample databases of the embodiments shown in FIGS. 2 and 3, sample ad records are displayed in rows 201-206 and sample registered viewer records are shown in rows 301-306 respectively. The ad database columns 210-222 and registered viewer database columns 310-316 correspond to the data fields of each record. As with the organization of the database themselves, it is to be understood that the data and fields within the databases can be readily modified from the described embodiment and adapted to provide variations for operating the system and method described. Furthermore, each field may contain more or less information. For example, the address fields may be consolidated into a single field containing street address, apartment number, city, state, zip code, and phone number.

Referring to the sample records in the database 200 as shown in FIG. 2, advertisement database 200 contains data fields 210-222 corresponding to, ad 210, ad ID 211, product category 212, company 213, company ID 214, methods 215, entrant count 216, entrant limit 217, run count 218, viewer 219, entrant 220, request 221, and prize 222.

The data fields for each record are populated from a combination of data provided by the advertiser 102, the ad server 110 and the viewer 106. For example, the ad 210, product category 212, company 213, methods 215, entrant limit 217, and prize 222 are typically provided by the advertisers 102. The ad ID 211, company ID 214, entrant count 216, run count 218, viewer 219, entrant 220 and request 221 are typically provided and maintained by the ad server 110.

Referring to FIG. 2, the ad field 210 contains the digitized ad or an address to the location of the digitized ad. The digitized ad is a digitally encoded data file containing the digitized image, video or audio data for the ad. The image, video, or audio may be stored in any of numerous known formats, such as Flash, JPEG, MPEG, Quicktime, AVI, Shockwave, etc., which can be created using commercially available software from Microsoft, Apple, Macromedia and others. The method field 215 may contain Java applets, source code, applications, plug-ins, or the like necessary to present the ad and offers to the viewers 106. The ad ID field 211 is a unique identifier assigned to each ad by the ad server 110 to uniquely identify each ad record 201-206. The product category 212 relates to the assignment of each ad to one or more categories of products or services i.e., category 11 may be toys, category 3 may be financial services, etc., and can be assigned by either the advertiser or the ad server. This feature enables the ad server to readily select ads from a particular category in response to a viewer's request or interest. The company field 213 identifies the advertiser by name. The company ID 214 is a unique identifier assigned to each company by the ad server.

Fields 216 through 221 are used by the ad server to record viewer requests and interactions with each ad. The entrant count field 216 maintains a record of the number of entries submitted since the last drawing for the offered prize. The entrant limit field 217 defines the point at which a drawing for a winner will be conducted. In the sample records shown, the entrant limit 217 is defined to trigger a drawing after the entrant count 216 equals or exceeds the entrant limit 217. For example, an entrant limit of one hundred indicates that the ad server will conduct a drawing after every one hundred viewer entries are received. In other embodiments, it is contemplated that the entrant limit 217 may alternatively define a date, period of time, or combination of events on whose occurrence the drawing is triggered. For example, the trigger to conduct a drawing may be set to occur on a specific date, or may be set to occur a certain number of days since the last drawing. In addition this field may contain a subfield or an additional field identifying how many winners should be selected at each drawing.

The run count field 218 contains the number of times the ad has been shown to viewers 106 since the records creation. This field may have a sub field or there may be an additional field which identifies a limit to the number of times the advertiser has chosen to show the ad or the number of prizes which the advertiser has chosen to give away. The viewer field 219 contains a list of the viewer ID's for all viewers who have viewed the advertisement. The entrant field 220 contains a list of viewer ID's for all viewers who have submitted an entry to win the offered prize. The request field 221 contains a list of viewer ID's for all viewers who have requested information, including literature, product samples or incentives from the advertiser. The prize field 222 indicates the prize or prizes being offered in conjunction with the viewing of each ad. The prize is preselected by the advertiser.

It is contemplated that the ad database 200 may also include fields to record and manage invoicing to advertisers for ad runs such that a field may record the number of ad runs prepaid, ad runs not paid, and the like, whereby these additional fields can facilitate calculation of advertising fees, automatic invoicing, and direct invoicing and payment via the network 100.

Exemplary records of the registered viewer database 300 are illustrated in FIG. 3. As shown in FIG. 3, the registered viewer database 300 contains data fields for viewer ID 310, name 311, street address 312, state 313, city 314, zip code 315, phone 316, and link log 317. These fields are primarily self-explanatory. The name 311, street address 312, state 313, city 314, zip code 315, and phone 316 fields containing the viewer contact information are provided by the viewer during the registration process. The viewer ID field 310 is a unique viewer identifier assigned by the ad server 110. The link log field 317 contains a log of advertiser e-commerce site links that the viewer 106 has stored. In addition to the fields shown in the sample, it is anticipated that the registered viewer database may also contain fields or subfields containing a password, a user id, additional demographic information and information related to, for example, the viewer's interests, purchasing habits, income level, and the like.

The registered viewer information database 300 serves to provide viewer contact and demographic information to the advertisers 102, and to permit the advertisers 106 to directly contact viewers 102 who have either won prizes or requested information. It is further provided, in accordance with preferred embodiments of the instant invention, that demographic, purchasing habit, income level data and the like obtained from the viewer may be used by the ad server 110 to target advertisements to viewers who are most likely to be interested in a particular product or service being offered.

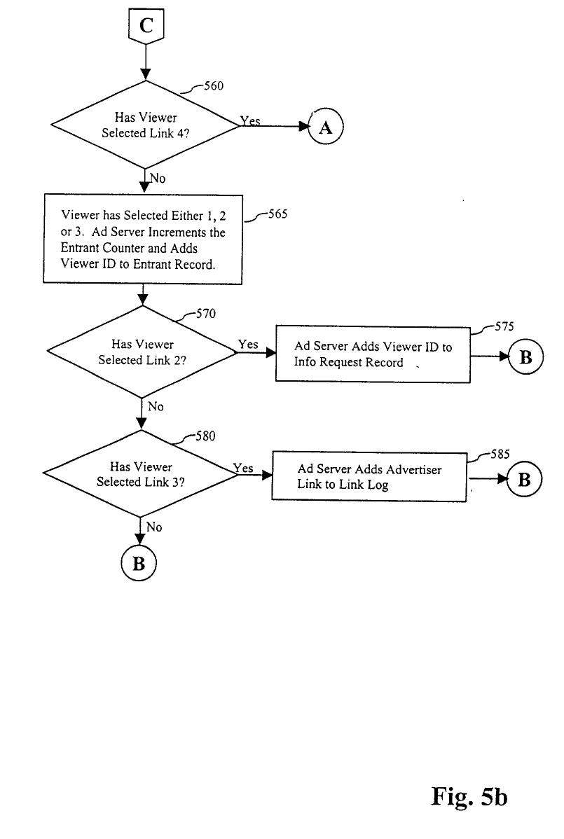

Having described the system architectures of the present embodiment, a summary of the process, and the associated sample database structures, the operation of the systems will now be described in detail with reference to the flowcharts in FIGS. 4, 5a and 5b.

5. Advertisement Handling Process

Referring to FIG. 4, handling of ads from advertisers and the creation of the ad database records will be described. As an initial step it is contemplated that the advertisers 102 prepare entertaining and informational advertisements of the length typical of a television commercial for distribution and storage on the ad server 110. The ad is stored and distributed in a standard digital format such as those discussed above in connection with the ad field 210.

Referring to step 405, the ad is transferred to the ad server 110 by any known method such as via network 100, direct connection, removable storage media, digital encoding directly to the ad server 110 from film, tape or the like. Alternatively, it is also contemplated that the digitized ad may be stored at a remote node on the network 100 such as on the advertiser's interface device 104.

In step 410, the ad server 110 creates a new ad record in the ad database 200 to store the ad and related data in data fields 210-222. As described above with respect to the sample ad records 201-206, the ad field 210 may contain either the digitized ad itself or, alternatively, an address to the digitized ad location on a remote node, such as the advertiser interface device 103. The ad ID 211 and company ID 213 are unique identifiers, assigned by the ad server, associated with the ad and the company respectively. The entrant count 216, run count 218, viewer 219, entrant IDs 220 and request 221 fields, which all record viewer interaction with the ad, are zeroed or cleared initially and are subsequently used by the ad server 110 to record viewer responses to each ad. Following creation and initialization of the ad record, the ad is available for transmission and display to viewers as illustrated in step 420. The details of the transmission, display, and viewer handling including collection of entries and information requests will be discussed with reference to FIGS. 5a-5b.

6. Viewer Handling Process

In one preferred embodiment hereof, for showing a series of ads to a viewer visiting the ad server website, referring to FIG. 5a, and beginning at step 500, a viewer 106 begins at the ad server's website. In Step 510, the ad server 110 determines whether the viewer 106 is a registered viewer. The determination can be accomplished through any known method such as by, receiving a “cookie” from the viewer identifying the viewer as a registered viewer, prompting the viewer to log-in using a user ID and password and confirming the viewer's identity against the registered viewer database, or like process. If the viewer is not a registered viewer, in step 515 the viewer is prompted to complete a registration form including at least the viewer's contact information. In Step 520, the information from the registration form is transmitted by the viewer interface device 103 to the ad server 110; the ad server 110 in turn creates the registered viewed record in the registered viewer database 300 and populates the record with the registration data from the viewer's completed registration form. Once the record is created, a confirmation of registration is sent to the viewer's E-mail in step 525.

Following registration steps 510-525, or if the viewer is a returning registered viewer from step 510, the process proceeds to step 530. In step 530, the viewer enters the ad server's main page and is offered the opportunity to (1) view ads at random from all categories of products and services, (2) to view ads from specific categories of products or services, or (3) to view ads from a log of viewer preferred advertisers—the log is generated by the viewer selection of one or more advertisers from which the viewer wishes to view ads. Thus, the viewer may chose to see an ad from all categories and advertisers, category specific ads such as computers, household products, cars, electronic, etc. or advertiser specific ads such as The Gap, Toy-R-Us, Dell, etc. In other embodiments, the user may not be offered the opportunity to select between all ads or ads for particular categories or advertisers such that step 530 is eliminated.

In an alternate preferred embodiment wherein the viewer is visiting a website (say website 108n) and the viewer, for example, has agreed to watch preferably a single ad to take advantage of the opportunity to win a prize, the website 108n will likely have registered the viewer as to at least contact information. Then ad server 110 provides such ad to the website for the viewing of the viewer in a similar manner as for the embodiment described in the preceding paragraph, as below described.

In step 535 the viewer's selection is transmitted to the ad server 110, the ad server 110 in turn selects an ad and transmits the ad to the viewer interface device 104. The ad is then received by the viewer interface device 104 and displayed to the viewer 106. The ad server 110 may select the ad from among the group of ads in the selected category, all categories, or the selected advertisers depending on the viewer's choice. The ad selection from among the ads may be by any known method, including, at random, based on the demographic information, viewer interests, viewer purchasing habits, or a combination thereof. [Or, for the alternate embodiment, the single ad will typically be one that the website 108n has asked the ad server 110 to send, typically because the advertiser has made an arrangement with the website 108n.]

Upon selection of the ad, at step 535, the ad server 110 increments the run-count field 218 of the selected ad record, adds the viewer's ID to the viewer field 219 and transmits the ad and any associated methods 215 to the viewer interface device 104. The methods may be Java applets, HTML code, plug-ins, or the like, required to present the ad to the viewer 106 via the viewer interface device 104. For example, where the viewer interface device is a desktop computer running a commercially available browser program such as Netscape Navigator or Internet Explorer, the method may contain the HTML or Java code controlling the way the ad is displayed, including presentation of the links or offers to the viewer, receipt of the viewer's response, and the like. In addition, the methods may also include plug-ins that enhance the functionality of the browser or viewer interface device 104 to properly display the ad.

Proceeding to step 540, the ad is received and displayed to the viewer 106 via the viewer interface device 104 and browser. It is provided that during the first portion of the ad, the viewer 106 is not offered the opportunity to enter to win the prize, request information, etc., i.e., there are no interactive elements present or active. As shown in step 545, during a second portion of the ad, links offering the opportunity to enter to win a prize, request information, add an advertiser link to the viewer's log, or go to the home page are either displayed or activated. The links then remain active for the duration of the ad. The timing of the link presentation or activation may be controlled through an associated method or code, such as Java or HTML, that instructs the browser to display the links and receive a response from the viewer 106. The effect of the delay before presenting the links is to prevent viewers from submitting entries without watching the ad and encourage the viewer to watch the ad while waiting for the links to appear or be activated.

As shown in step 550, during the second portion of time the viewer interface device 104, monitors the viewer response to detect the viewer's decision to submit an entry. For example, where the viewer interface device 104 is a desktop computer running browser software, a Java applet or the like may be used to present the ad, activate the links, and monitor viewer activity. The viewer activity is monitored by a repetitive loop such as that illustrated in steps 550 and 555. Step 550 checks to see if the viewer 106 has selected a link. If the viewer 106 has not selected a link, the process proceeds to step 555 and determines whether the ad has concluded. If the viewer 106 has not selected a link and the ad has not concluded, then the loop repeats with step 550. If the ad has concluded in step 555, the process returns to step 535 to request the next ad from the ad server 110. The process then starts again, receiving and displaying the new ad as described above for the embodiment where a series of ads is presented to a registered viewer at the ad server website, for example.

Referring back to step 550, if the viewer selects one of the offered links before the ad has concluded, the process proceeds to step 560 (see FIG. 5b). In steps 560-580, the viewer's link selection is determined from among the active links. In the embodiment disclosed in FIGS. 5a and 5b, the viewer is offered four links: (1) “Enter Me”; (2) “Enter Me and Send Info”; (3) “Enter Me and Store Link to Log”; and (4) “Home”.

Step 560 determines if the viewer has selected “Home” for return to the homepage. If so, the process returns to step 530, wherein the viewer may choose from among the offerings on the home page, including the option to view more ads from another category of products or services, other advertisers, or from all categories and advertisers. If the viewer has not selected “Home”, then the viewer has selected one of the other links (“Enter Me”, “Enter Me and Send Info” or “Enter Me and Store Link to Log”), all of which include the action of submitting an entry. Therefore, in the following step 565 the ad server 110 identifies the viewer as an entrant by recording the viewer's ID in the entrant field 220 and incrementing the entrant count field 216 to reflect the submission of another entry.

Steps 570 and 580 determine whether, in addition to submitting an entry, the viewer 106 has also requested either more information from the advertiser 120 by selecting “Enter Me and Send Info”, or to add a link to the advertiser's web site to the viewer's log by selecting “Enter Me and Store Link to Log”. Step 570 determines whether the viewer 106 has selected “Enter Me and Send Info”. If the viewer 106 has requested information, in step 575 the ad server 110 adds the viewer's ID to the request field 221 and the process returns to step 535 to select the next ad.

Step 580 determines whether the viewer 106 has selected to add the advertiser's e-commerce site link to the link log 317. If the viewer has selected to add the link, in step 585 the ad server 110 adds the advertiser link to the link log field 317 and the process returns to step 535 to select the next ad. The link log 317 is stored for the viewer whereby the viewer can easily access the link log 317 from within the browser and link to the advertiser's e-commerce sites after ad viewing is complete. In other embodiments of the invention, the viewer may have the option to “Enter and Link”, allowing the viewer to link directly to the advertiser's web site in a new browser window, leaving the ad browser window visible. In any of these embodiments it should be understood that additional revenues can be generated by collecting “click through” fees plus a percentage of sales from e-commerce sites accessed by viewers linking to the e-commerce sites from the ad server.

If the viewer 106 has not selected the link requesting more information or to store the link in the link log, by default the user has selected “Enter Me”. Since the entry was already submitted in step 565 no additional action is taken and the process returns to step 535 to select the next ad. It is provided that in the above steps, after a link is selected the ad will continue to run to its conclusion before the next ad is selected in step 535.

The details of receiving and recording viewer responses, and selecting a winning entrant or entrants will be discussed with reference to FIG. 4.

7. Winner Selection and Prize Handling

Referring to FIG. 4, each ad stored in the ad database 200 is shown to a plurality of viewers 104, and viewer IDs and viewer responses to each ad are collected and compiled in the associated ad record and/or registered viewer record. Namely, as shown in FIG. 2, for each ad record, each time an ad is shown to a viewer, that viewer's ID is added to the viewer field 219 for that ad record. Similarly, each time a viewer responds to the ad by submitting an entry, submitting an entry and requesting information, or submitting an entry and adding the advertiser's link log, the following actions are taken respectively, the viewer's ID is added to the entrant field 220, the entrant field 220 and request field 221, or the entrant field 220 and link is added to the link log field 317.

Referring back to step 420, the ad server 110 has shown an ad to a viewer 106, the viewer has finished viewing the ad and the ad server has received and recorded the viewer's response. In step 425, the ad server 110 next determines whether it is time to select a winner or winners for the offered prize. As previously discussed, the triggering event for prize selection may be based on events such as the time elapsed since the last drawing, a scheduled date, the number of entrants received, or a combination thereof. In one embodiment the triggering event is the number of entrants. By example, referring to ad record 202 shown in FIG. 2, assume the Yahoo Travel ad has just been shown to a viewer 106 and an entry submitted. Since the entrant count 216 has reached the entrant limit 217, the drawing is triggered and the ad server 110 randomly selects a winner or winners from among the viewer ID's stored in the entrant field 220.

After selecting the winning entry or entries, in step 435 the ad server 110 transmits the viewer contact information for the winning viewer or viewers to the advertiser 102, so that the advertiser may send the prize directly to the winning viewer or viewers as illustrated in step 440. The ad server 110 may at the same time or at an independent period or interval, also transmit viewer contact information for all viewers who have requested information from the advertiser, so that the advertiser may send product or service information, including literature, product samples or incentives directly to the viewer 106. In addition, at an advertiser's request and based on the advertiser's subscription plan the ad server 110 may also transmit viewer contact information for all registered viewers in the viewer database 300, all viewers who have viewed the advertiser's ad, all viewers who submitted entries, and/or all viewers who have stored the advertiser's link in their link log 317. This data can be marketed to advertisers for use in developing marketing plans as well as in evaluating the effectiveness and reach of its ad.

After transmitting the viewer contact information for the various categories discussed above to the advertiser 102, in step 435 the ad server 110 next notifies the winner or winners of prize winnings. It should be understood that notification may be accomplished by any known means such as, by E-mail, phone, fax, web site winners board, or the like. After notification of the winner or winners, the ad record in the ad database 200 is reinitialized in step 415. Namely, before the collection of entrants for the next prize drawing can begin, the entrant field 220 must be cleared and the entrant count field 216 zeroed. This prize selection process and data transmission are preferably implemented on an ad-by-ad basis for all ads in the ad database 200 as ads are shown to viewers 106 and entries collected. Once the winner and viewer information requests are transmitted to the advertiser 102 the advertiser is preferably responsible for sending or transmitting the prize or requested information, including literature, product samples or incentives directly to the viewers 106.

A similar system to that above described is used when the ad server is determining a winner from single ads shown to viewers at participating websites 108n. And the winner information is also preferably transmitted to the advertiser for prize implementation.

8. Preferred Screen Displays and Modifications Thereof.

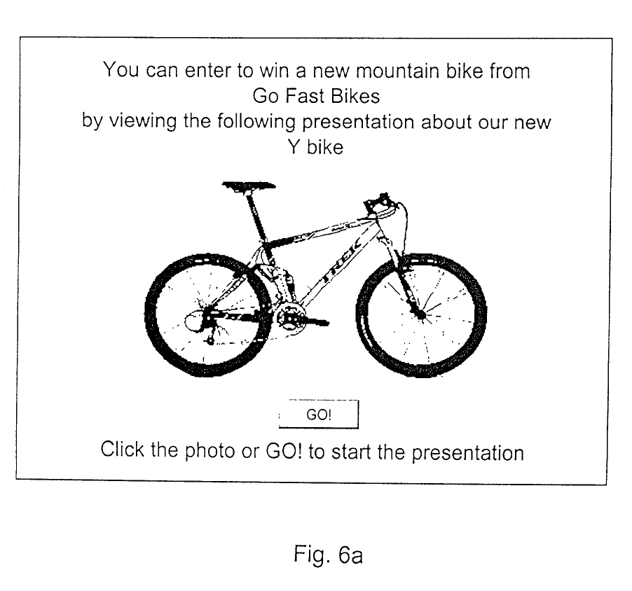

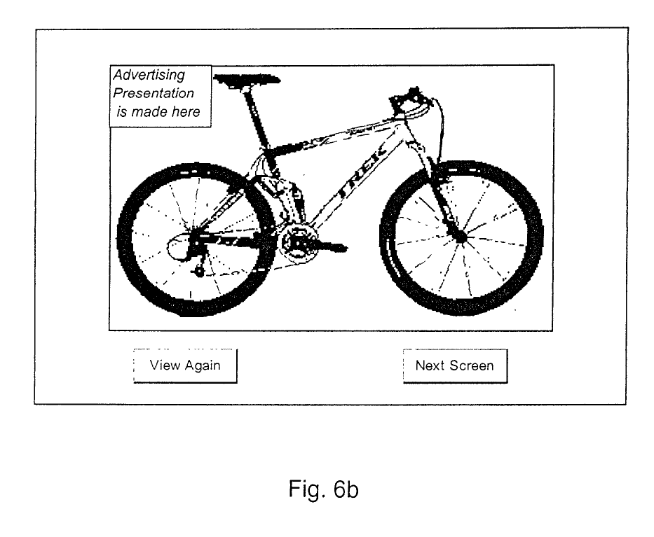

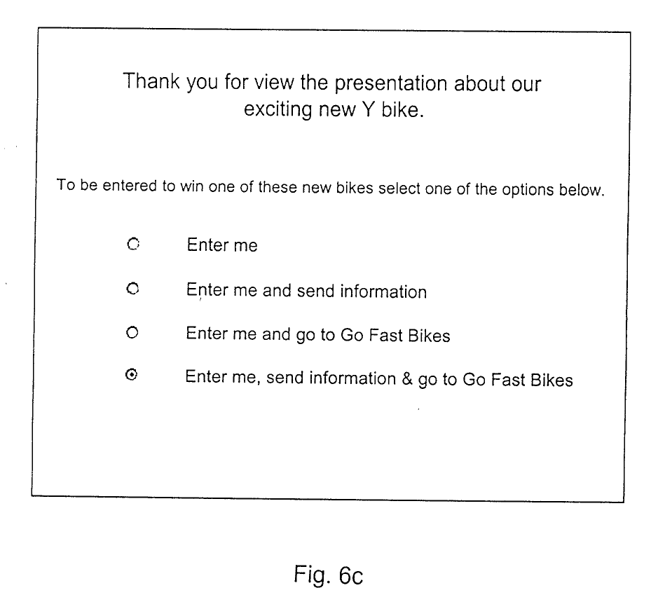

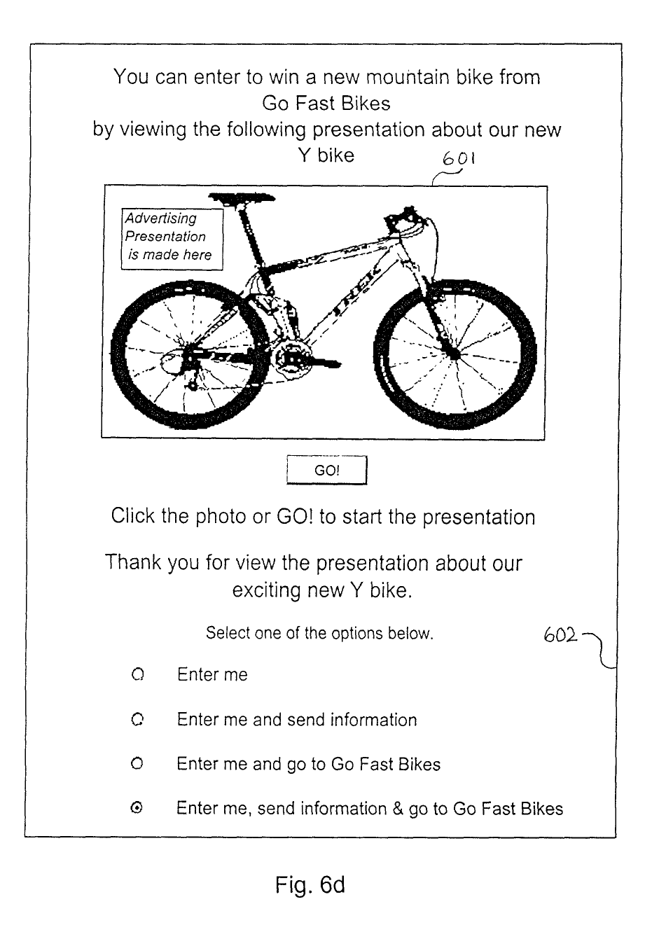

Referring to FIGS. 6a, 6b, and 6c, these figured show a typical preferred order and content of screens presented to the viewer in connection with a preferred embodiment of this invention. In the screen illustrated by FIG. 6a, as shown, the viewer is apprised that the viewer can enter to win a prize by viewing “the following presentation” or an explanation to that effect. Preferably, when the viewer clicks ahead, a screen like that of FIG. 6b appears, preferably showing the ad, which is preferably interstitial and dynamic. At the conclusion of the ad, either the next screen is quickly presented or, as shown in FIG. 6b, the viewer has the choice to re-view the ad or move on. The next screen preferably presented to the viewer is typically similar to that of FIG. 6c, a screen, as shown, permitting the “clicking” (in well-known ways) of one of a series of buttons or other clickable areas on the screen wherein the viewer preferably chooses from among: “Enter me”; “Enter me and send information”; “Enter me and go to (the advertiser's website)”; or “Enter me, send information & go to (the advertiser's website)”.

In an alternate preferred embodiment, as shown in FIG. 6d, two or more of the screens of FIGS. 6a-c may be combined. In this embodiment, the bottom of the screen of FIG. 6d (having the “enter” buttons/areas) will preferably not be presented until a period of time has elapsed. This greatly improves the chances that the viewer will become engaged with the ad before “entering” and then ignoring the ad. Preferably, a button activation message will be presented to the viewer at/before the beginning of the ad informing the viewer when an entry may be made and/or when the entry buttons will appear. The entry buttons preferably may appear, in the format of FIG. 6d, either below the screen area 601 showing the ad, or the ad may use a larger area 602 and the entry buttons may appear within the ad area after such period of time has elapsed.

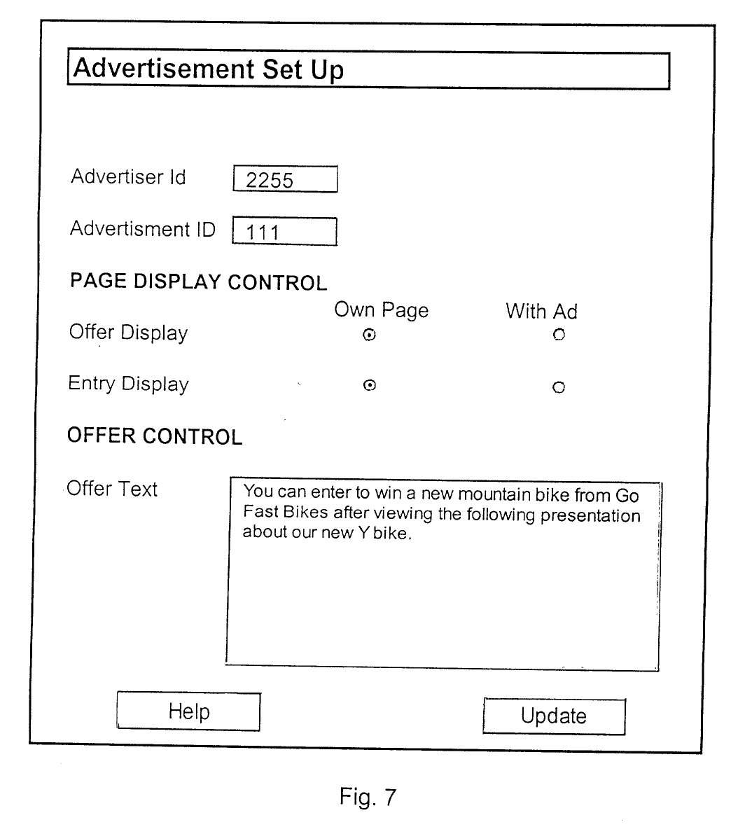

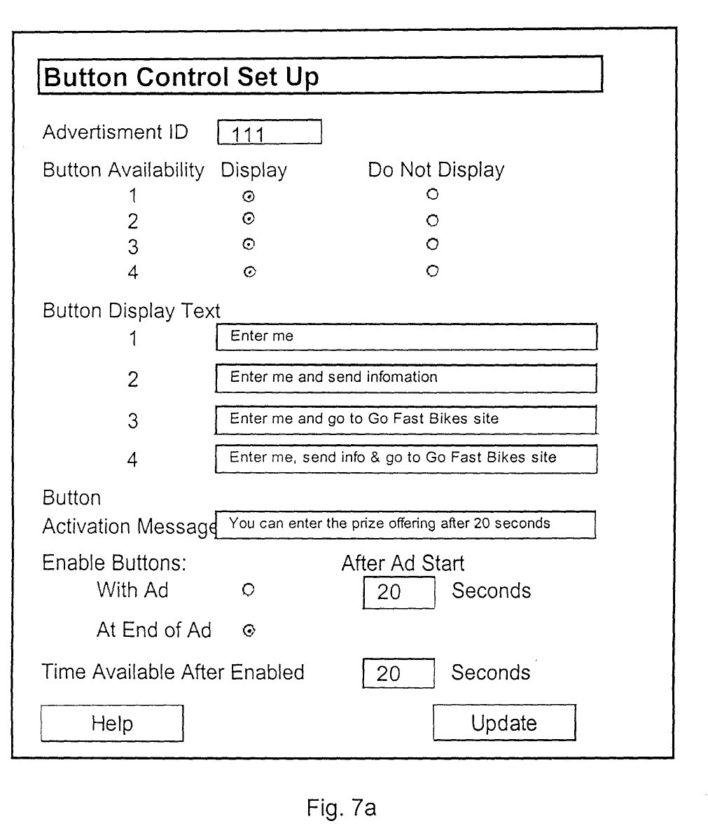

Referring to FIGS. 7 and 8, example screens are shown to assist an ad server operator or similar person in setting up ad presentations (see FIGS. 6a-d) according a preferred embodiment of this invention. FIG. 7 illustrates an example set up of the following variables: Advertiser ID; Advertisement ID; Whether the Offer display is to be shown with the ad or have its own page; Whether the Entry display is to be shown with the ad or have its own page; what the offer text should be. FIG. 8 illustrates an example set up screen for button variables, including: Advertisement ID; Which buttons to display; The button display text for each button; The text for the button activation message; When to enable the entry buttons (i.e., with the ad, at the end of the ad, or a specified time after the ad start); A Time that the entry buttons are available after they are enabled. Preferably, the viewer will be able to reactivate the buttons to show the ad again by using the Show Again button.

9. Preferred time-period settings of variables for maximizing ad attention.

The above options to set up entry buttons will preferably be available whether or not the described screens to set entry variables are used. In a preferred embodiment hereof, text near the entry buttons would state something like: “prize-offering entry buttons will be live in 15 seconds—in the meantime, enjoy the entertainment”; or “you can enter the prize-offering in 15 seconds”; or “you can enter the prize-offering in 15 seconds” (with the number of seconds counting down: 15, 14, 13, etc.). Although more confusing and not preferred, this could also be done by having the entry buttons displayed in a particular color or shape when they are dead and change into another color or shape when they are live.

In order to better insure viewers are focusing on the ads, it is preferred to set a time limit for the entry buttons. For example, from the time they become live/available, they could only be available to click-to-enter for a pre-set period of time (preferably about 15 seconds), or until one is clicked on, whichever occurs sooner. At that point, the ad will automatically close/exit.

It is noted that, from the advertisers' perspective, having the ad time-period end prior to allowing the viewer to enter the prize-offering is ideal. But from the viewers' perspective, having no ad time period, prior to being able to enter the prize-offering, is the preferred method. Viewers would simply click to enter as fast as possible, in order to move on to click to enter additional prize-offerings. However, most advertisers might not be willing to pay for this method as there would be very little to no “branding” time. According to the present invention, the preferred ad time period range, prior to being able to enter the prize-offering, is 5-30 seconds, depending upon the ad format. For example, a Banner ad time period, prior to being able to enter the prize-offering, is preferably a minimum of 5 seconds. A full-screen dynamic TV-type/Interstitial ad time period, prior to being able to enter the prize-offering, is preferably a maximum of 30 seconds. Further, it may be that advertisers' 30-second TV commercials will be digitized and used as a new Internet ad format.

It is also noted that, although buttons of some sort are preferred, a viewer might be allowed to simply “click” anywhere on the ad itself or use another method of entry under appropriate circumstances; and/or entry buttons/mechanism may be hidden until after an ad time period has elapsed or made minimal in size as the ad begins and enlarge during, or at the end, of the ad.

In summary, it is highly preferred, to achieve the best results with the embodiments of the present invention, that the entry opportunity not be offered to the viewer until an ad time period of at least about 5 seconds has elapsed and no more than about 30 seconds has elapsed, and more preferably, an about 5-20 second range. And it is highly preferred that the entry mechanisms be available for no less than about 5 seconds and no more than about 30 seconds. It is also highly preferred, to achieve such best results, that any prize be preselected by the advertiser and that selection of the advertisement be based on demographic information about the viewer.

It should be understood that various modifications and variations can be made in the system and processes of the present invention without departing from the spirit or scope of the invention. Thus, it is intended that the present invention cover the modifications and variations of this invention provided they will come within the scope of the appended claims and their equivalence. In this context, equivalence means each and every implementation for carrying out the functions recited in the claims, even if not explicitly described herein.

What is claimed is:

1. A system of advertising to a viewer wherein by viewing an advertisement of an advertiser a viewer may qualify to win a prize, comprising:
a) transmitting an advertisement to a viewer;
b) transmitting to the viewer an offer to submit an entry to win a prize in response to the advertisement wherein the viewer is offered the opportunity to submit the entry only after the advertisement has been displayed to the viewer for a period of time;
c) receiving an entry for the prize from the viewer; and
d) selecting an entry as a winning entry to receive a prize.

2. A system of advertising to at least one viewer wherein by permitting display to the viewer of at least one advertisement, the viewer may qualify to win at least one prize, comprising:
a) displaying to the viewer, in connection with the display of the advertisement, an immediate opportunity to submit at least one entry to win the prize;
b) wherein the viewer is offered the immediate opportunity only after the advertisement has been displayed to the viewer for a period of time.

3. A computer system of advertising to at least one viewer wherein by permitting display to such at least one viewer of at least one advertisement of at least one advertiser, such viewer may qualify to win at least one prize, comprising:
a) displaying such advertisement to such viewer for a first period of time; and
b) displaying to such viewer, in connection with such displaying of such advertisement, an immediate opportunity to submit at least one entry to win such at least one prize;
c) wherein such viewer is offered such immediate opportunity only after such advertisement has been displayed to such viewer for a second period of time;
d) wherein such immediate opportunity is offered to such viewer only for a third period of time;
e) wherein the second period of time is no more than about the first period of time; and
f) wherein the third period of time is no less than about five seconds.

4. The system according to claim 3 wherein the first period of time is no less than about five seconds.

5. The system according to claim 3 wherein the second period of time is no less than about five seconds.

6. The system according to claim 5 wherein the second period of time is no more than about thirty seconds.

7. The system according to claim 3 wherein the second period of time is no more than about thirty seconds.

8. The system according to claim 3 wherein the third period of time is no more than about thirty seconds.

9. The system according to claim 3 wherein:
a) the second period of time is no less than about five seconds; and
b) the second period of time is no more than about twenty seconds.

10. The system according to claim 3 further comprising:
a) receiving such at least one entry from such viewer; and
b) selecting such at least one entry as at least one winning entry to receive such at least one prize.

11. The system according to claim 3 further comprising displaying to such viewer an entry system structured and arranged to implement such submission of such at least one entry by viewer “clicking” of at least one designated area of a viewer display device.

12. The system according to claim 11 wherein such viewer “clicking” is accomplished by only one “click”.

13. The system according to claim 11 wherein such designated area comprises at least one button.

14. The system according to claim 11 wherein such entry system is further structured and arranged to include an optional viewer-opportunity to request information from such advertiser.

15. The system according to claim 11 wherein such entry system is further structured and arranged to include an optional viewer-opportunity to request linking such viewer to a website of such advertiser.

16. The system according to claim 13 wherein such viewer “clicking” is accomplished by only one “click”.

17. The system according to claim 13 wherein such button comprises, at least in part, essentially the words “Enter Me”.

18. The system according to claim 3 further comprising displaying to such viewer an indication of when such offer will be made of such immediate opportunity to submit such at least one entry to win such at least one prize.

19. The system according to claim 18 wherein such displaying of such advertisement to such viewer comprises such indication.

20. The system according to claim 19 wherein such indication comprises a countdown of essentially how much time remains of such second period of time.

21. The system according to claim 3 wherein such advertisement comprises a dynamic interstitial advertisement.

22. A system of advertising, comprising:
a) preparing an advertisement for display to a viewer in exchange for offering the viewer an opportunity to submit an entry to win a prize in conjunction with viewing the advertisement wherein the opportunity to submit the entry is only available after the advertisement has been displayed to the viewer for a period of time;
b) transmitting the advertisement to an ad server for transmission to viewers;
c) receiving viewer contact information for each viewer selected to win a prize; and
d) transmitting each selected viewer a prize.

23. A computer system of advertising to at least one viewer wherein, by viewing at least one advertisement of an advertiser, such viewer may qualify to win at least one prize, comprising:
a) storing a plurality of such advertisements on at least one server;
b) registering a plurality of such viewers by obtaining viewer information data for each such viewer including at least such viewers' contact information; and
c) implementing display of at least two of such plurality of such advertisements to at least one selected viewer for display in series on a viewer interface device, such implementing being structured and arranged to provide
i) displaying of each individual advertisement to such selected viewer for a first period of time,
ii) displaying to such selected viewer, in connection with the display of such individual advertisement, of an immediate opportunity to submit at least one entry to win such at least one prize,
iii) wherein such selected viewer is offered such immediate opportunity only after such individual advertisement has been displayed to such selected viewer for a second period of time,
iv) wherein such immediate opportunity is offered to such selected viewer only for a third period of time,
v) wherein the second period of time is no more than about the first period of time, and
vi) wherein the third period of time is no less than about five seconds; and
d) determining for each such individual advertisement whether each such selected viewer chose to submit an entry for the associated prize;
e) identifying any such selected viewers, who chose to submit an entry, as entrants;
f) selecting at least one such entrant as a winner to receive such at least one prize; and
g) notifying such at least one winner of a winning of such at least one prize.

24. The system according to claim 23 wherein the first period of time is no less than about five seconds.

25. The system according to claim 23 wherein the second period of time is no less than about five seconds.

26. The system according to claim 25 wherein the second period of time is no more than about thirty seconds.

27. The system according to claim 23 wherein the second period of time is no more than about thirty seconds.

28. The system according to claim 23 wherein the third period of time is no more than about thirty seconds.

29. The system according to claim 23 wherein:
a) the second period of time is no less than about five seconds; and
b) the second period of time is no more than about twenty seconds.

30. The system according to claim 23 further comprising displaying to such selected viewer an entry system structured and arranged to implement such submission of such at least one entry by viewer “clicking” of at least one designated area of a viewer display device.

31. The system according to claim 30 wherein such viewer “clicking” is accomplished by only one “click”.

32. The system according to claim 30 wherein such designated area comprises at least one button.

33. The system according to claim 30 wherein such entry system is further structured and arranged to include an optional viewer-opportunity to request information from such advertiser.

34. The system according to claim 30 wherein such entry system is further structured and arranged to include an optional viewer-opportunity to request linking such selected viewer to a website of such advertiser.

35. The system according to claim 30 wherein such viewer “clicking” is accomplished by only one “click”.

36. The system according to claim 30 wherein such button comprises, at least in part, essentially the words “Enter Me”.

37. The system according to claim 23 further comprising displaying to such selected viewer an indication of when such offer will be made of such immediate opportunity to submit such at least one entry to win such at least one prize.

38. The system according to claim 37 wherein such displaying of such individual advertisement to such selected viewer comprises such indication.

39. The system according to claim 38 wherein such indication comprises a countdown of essentially how much time remains of such second period of time.

40. The system according to claim 23 further comprising:
a) selecting such advertisement to transmit to such viewer from a category of such advertisements requested by such viewer; and
b) selecting such advertisement to transmit to such viewer from a list of advertisers selected by such viewer;
c) wherein such advertisement comprises a dynamic interstitial advertisement.

41. A computer system of advertising to at least one viewer wherein by permitting display to such at least one viewer of at least one advertisement of at least one advertiser, such viewer may qualify to win at least one prize, comprising:
a) means for displaying such advertisement to such viewer for a first period of time; and
b) means for displaying to such viewer, in connection with such displaying of such advertisement, an immediate opportunity to submit at least one entry to win such at least one prize, so that
i) such viewer is offered such immediate opportunity only after such advertisement has been displayed to such viewer for a second period of time, and
ii) such immediate opportunity is offered to such viewer only for a third period of time;
c) wherein the second period of time is set at no more than about the first period of time; and
d) wherein the third period of time is set at no less than about five seconds.

42. The system according to claim 41 wherein the first period of time is set at no less than about five seconds.

43. The system according to claim 41 wherein the second period of time is set at no less than about five seconds.

44. The system according to claim 43 wherein the second period of time is set at no more than about thirty seconds.

45. The system according to claim 41 wherein the second period of time is set at no more than about thirty seconds.

46. The system according to claim 41 wherein the third period of time is set at no more than about thirty seconds.

47. The system according to claim 41 wherein:
a) the second period of time is set at no less than about five seconds; and
b) the second period of time is set at no more than about twenty seconds.

48. The system according to claim 41 further comprising:
a) means for receiving such at least one entry from such viewer; and
b) means for selecting such at least one entry as at least one winning entry to receive such at least one prize.

49. The system according to claim 41 further comprising means for displaying to such viewer an entry system structured and arranged to implement such submission of such at least one entry by viewer “clicking” of at least one designated area of a viewer display device.

50. The system according to claim 49 wherein such viewer “clicking” is accomplished by only one “click”.

51. The system according to claim 49 wherein such designated area comprises at least one button.

52. The system according to claim 49 wherein such entry system is further structured and arranged to include an optional viewer-opportunity to request information from such advertiser.

53. The system according to claim 49 wherein such entry system is further structured and arranged to include an optional viewer-opportunity to request linking such viewer to a website of such advertiser.

54. The system according to claim 51 wherein such viewer “clicking” is accomplished by only one “click”.

55. The system according to claim 51 wherein such button comprises, at least in part, essentially the words “Enter Me”.

56. The system according to claim 41 further comprising means for displaying to such viewer an indication of when such offer will be made of such immediate opportunity to submit such at least one entry to win such at least one prize.

57. The system according to claim 56 wherein such displaying of such advertisement to such viewer comprises such indication.

58. The system according to claim 57 wherein such indication comprises a countdown of essentially how much time remains of such second period of time.

59. The system according to claim 41 wherein such advertisement comprises a dynamic interstitial advertisement.

60. A system of advertising to at least one viewer wherein by permitting display to the viewer of at least one advertisement of an advertiser, the viewer may qualify to win at least one prize, comprising:
a) means for displaying to the at least one viewer, in connection with the display of the at least one advertisement, an immediate opportunity to submit at least one entry to win the at least one prize; and
b) means for offering to the at least one viewer such immediate opportunity only after the at least one advertisement has been displayed to the at least one viewer for a period of time having a first portion of time during which the at least one viewer is not offered such immediate opportunity to submit the at least one entry to win the at least one prize followed by a second portion of time during which the at least one viewer is offered such immediate opportunity to submit the at least one entry to win the at least one prize.

61. A computer system for advertising to a viewer wherein, by viewing an advertisement of an advertiser, a viewer may qualify to win a prize, comprising an ad server configured to:
a) transmit an advertisement to a viewer;
b) transmit an offer to submit an entry to win a prize to the viewer in conjunction with viewing the advertisement wherein the viewer is offered the opportunity to submit the entry only after the advertisement has been displayed to the viewer for a period of time;
c) receive an entry for the prize from the viewer; and
d) select an entry as a winning entry to receive a prize.

62. The system according to claim 61, wherein the ad server is further configured to transmit a plurality of advertisements to the viewer to be displayed in series.

63. The system according to claim 61, wherein the ad server is further configured to select an advertisement for transmission to the viewer based on demographic information of the viewer.

64. The system according to claim 61, wherein the ad server is further configured to select an advertisement to transmit to the viewer from a category of advertisements requested by the viewer.

65. The system according to claim 61, wherein the ad server is further configured to select an advertisement to transmit to the viewer from a list of advertisers selected by the viewer.

66. The system according to claim 61, wherein the ad server is further configured to receive viewer information data, wherein the viewer information data includes at least viewer contact information.

67. The system according to claim 66, wherein the ad server is further configured to store the viewer information data for each viewer submitting an entry.

68. The system according to claim 67, wherein the ad server is further configured to select the winning entry from among the stored viewer information data for each viewer submitting an entry.

69. The system according to claim 66, wherein the ad server is further configured to transmit the viewer information data, for the viewer submitting the winning entry, to the advertiser, whereby the advertiser may send the prize to the winner.

70. The system according to claim 61, wherein the ad server is further configured to notify the viewer submitting the winning entry that they have won the prize.

71. The system according to claim 61, wherein the ad server is further configured to offer the viewer an opportunity to request information from the advertiser.

72. The system according to claim 61 wherein the ad server is further configured to offer the viewer an opportunity to be linked to a website of the advertiser.

73. A system for advertising to a viewer wherein by viewing an advertisement of an advertiser a viewer may qualify to win a prize, comprising an ad server configured to:
a) receive a plurality of advertisements;
b) store the advertisements on a server;
c) register a plurality of viewers by obtaining viewer information data for each viewer including at least the viewers' contact information;
d) transmit the plurality of advertisements to each viewer for display on a monitor in series, wherein each advertisement is an interstitial advertisement having an associated prize offering, the advertisement being displayed for a time period having a first portion of time during which the viewer is not offered an opportunity to submit an entry to win the prize followed by a second portion of time during which the viewer is offered the opportunity to submit an entry to win the prize;
e) determine for each advertisement whether each viewer chose to submit an entry for the associated prize;
f) identify the viewers, who chose to submit an entry, as entrants;
g) select an entrant as a winner to receive the prize; and
h) notify the winner that they have won the prize.

74. A system for computer executable software code stored on a computer readable medium, the code for advertising to a viewer wherein, by viewing an advertisement of an advertiser, a viewer may qualify to win a prize, comprising:
a) code to transmit to the viewer, in connection with a transmitted advertisement, an offer to submit at least one entry to win a prize in response to the advertisement wherein the viewer only has the opportunity to submit the entry only after the advertisement has been displayed to the viewer for a period of time;
b) code to receive an entry for the prize from the viewer; and
c) code to select an entry as a winning entry to receive a prize.

75. The system according to claim 66, further comprising code to transmit a plurality of advertisements to the viewer to be displayed in series.

76. A system as in any one of claims 1-75 in which:
a) the prize is preselected by the advertiser.

77. A system as in any one of claims 1-75 in which:
a) selection of the advertisement is based on demographic information about the viewer.
